(19) United States
(12) Patent Application Publication
(10) Pub. No.: US 2008/0129265 A1
(43) Pub. Date: Jun. 5, 2008

(54) PULSE WIDTH MODULATOR WITH SYSTEMATIC FREQUENCY SHIFTING AND CONTROLLING METHOD THEREOF

(75) Inventor: BRUCE ROSENTHAL, Los Gatos, CA (US)

Correspondence Address: Freda Hsiung, Suite 201, 3100 De La Cruz Blvd, Santa Clara, CA, 95054, US

(73) Assignee: Analog Microelectronics Inc., Santa Clara, CA (US)

(21) Appl. No.: 11/941,527

(22) Filed: Nov. 16, 2007

Related U.S. Application Data
(60) Provisional application No. 60/859,108, filed on Nov. 16, 2006.

(51) Int. Cl. G05F 1/10; G05F 1/00

(52) U.S. Cl. 323/283; 323/282

(57) ABSTRACT

The configurations of a switching regulator and the controlling methods thereof are provided. The proposed switching regulator includes a pulse-width modulation controller generating a pulse train, an output driver receiving the pulse train and generating a driving signal so as to turn an external switch on/off, and a tri-mode clock controller including a system clock generating a clock signal to control a timing of the pulse train and a tri-mode circuitry receiving a feedback signal of an output voltage across an external load and generating a control signal to control a frequency of the clock signal according to the feedback signal.

### FIELD OF THE INVENTION

The present invention relates to a pulse width modulator (PWM). More particularly, the present invention relates to a PWM with systematic frequency shifting.

### BACKGROUND OF THE INVENTION

Pulse width modulators have been developed which incorporate various forms of frequency control to save power under light or no-load conditions. For example, LTC U.S. Pat. No. 5,481,178 generates a control signal to disable one or more switching transistors. Sometimes referred to as “Burst-Mode” or “Sleep-Mode”, these devices characteristically have high output ripple which is detrimental in many applications. Other schemes use variable frequency control (PFM) to save power and reduce ripple. Unfortunately, the resulting wide range in switching frequency gives rise to RFI and, or other forms of interference.

Keeping the drawbacks of the prior arts in mind, and employing experiments and research full-heartily and persistently, the applicant finally conceived a pulse width modulator with systematic frequency shifting and controlling method thereof.

### SUMMARY OF THE INVENTION

It is the object of the present invention to provide a high efficiency switching regulator over a broad current range while maintaining excellent output regulation and minimal interference.

In accordance with these objectives, circuits and methods are described which detect a narrow on-time pulse and systematically lower the switching frequency. In so doing, switching losses are reduced. The frequency is decreased in finite steps to reflect the change in load. Additionally, the frequency can be divided down to a sub-harmonic of the original frequency, so as not to interfere with another known circuit.

Additionally, circuits and methods which restrict the maximum pulse width at low clock frequency are included.

Additionally, circuits and methods for detecting an increased load, and the ability to smoothly transition back to a higher frequency are included.

In one implementation, a switching regulator operating at 500 KHz and full power, would drop back to 100 KHz at light-load, and 20 KHz with no-load. In a second implementation, the frequency would systematically drop from 80 KHz to 20 KHz and finally “hiccup” mode.

Various schemes for recognizing when to shift the frequency are considered. These include sensing the pulse width, sensing the error amplifier voltage in a PWM, and sensing the output voltage of the switching regulator.

The present invention may best be understood through the following descriptions with reference to the accompanying drawings, in which:

### BRIEF DESCRIPTION OF THE DRAWINGS

FIG. 1 is a system block diagram of a switching regulator having systematic frequency shifting according to the first preferred embodiment of the present invention;

FIG. 2 is a simplified block diagram of a switching regulator having systematic frequency shifting according to the first preferred embodiment of the present invention;

FIG. 3 is a detailed block diagram of a switching regulator having systematic frequency shifting according to the first preferred embodiment of the present invention;

FIG. 4 is an system clock with pulse width limiting at the low clock frequency according to the first preferred embodiment of the present invention;

FIG. 5 is a circuit for recognizing when to shift the frequency, up, or down according to the first preferred embodiment of the present invention;

FIG. 6(a) is a simplified block diagram of a switching regulator having systematic frequency shifting according to the second preferred embodiment of the present invention;

FIG. 6(b) is a scheme for detecting narrow pulses according to the second preferred embodiment of the present invention;

FIG. 7(a) is a simplified block diagram of a switching regulator having systematic frequency shifting according to the third preferred embodiment of the present invention; and

FIG. 7(b) is an alternate scheme for detecting narrow pulses according to the third preferred embodiment of the present invention.

### DETAILED DESCRIPTION OF THE PREFERRED EMBODIMENT

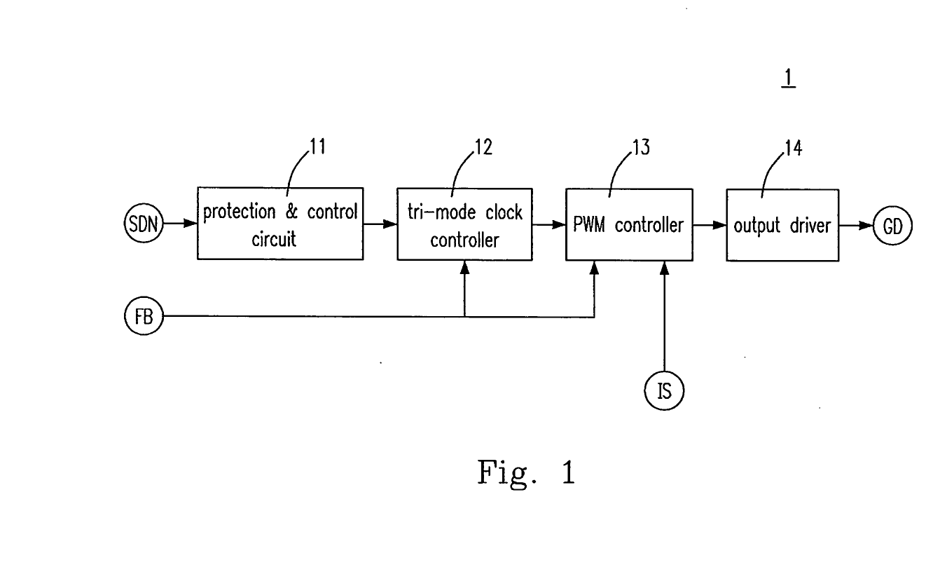

Please refer to FIG. 1, which shows a system block diagram of a switching regulator having systematic frequency shifting according to the first preferred embodiment of the present invention. In which, the proposed switching regulator 1 includes a protection and control circuit 11, a tri-mode clock controller 12, a pulse-width modulation (PWM) controller 13 and an output driver 14. The protection and control circuit 11 receives an external shutdown signal SDN input by a user to shutdown the switching regulator 1, and the protection and control circuit 11 could also shutdown the switching regulator 1 when the temperature inside the switching regulator 1 is higher than a predetermined level. The PWM controller 13 receives a feedback signal of an output voltage across an external load (not shown) via an external terminal FB and a current sense signal from a current sensor (not shown) via an external terminal IS and generates a pulse train. The output driver 14 receives the pulse train and outputs a driving signal to a gate drive GD so as to turn an external switch (not shown) on/off. The tri-mode clock controller 12 receives the feedback signal FB, generates a clock signal to control a timing of the pulse train and generates a control signal to control a frequency of the clock signal according to the feedback signal. The external switch operates under a relatively low frequency when the external load is relatively lighter, the external switch operates under a relatively high frequency when the external load is relatively heavier, and the switch operates under a relatively low frequency for a pre-determined period of time and then turns off when the external load is absent (under a burst mode/no-load mode).

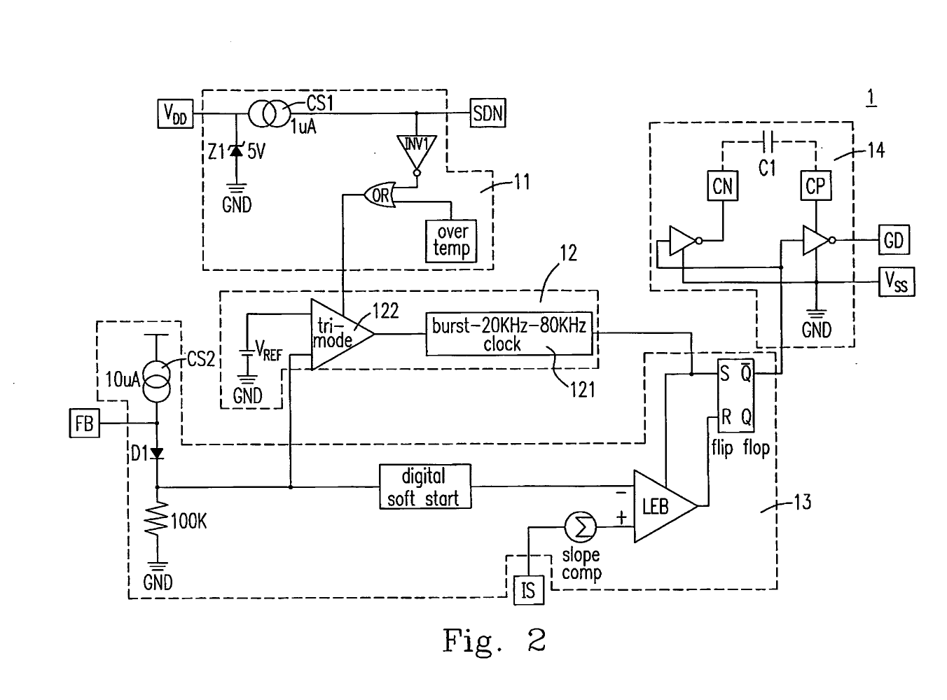

Referring to FIG. 2, which is a simplified block diagram of a switching regulator 1 having systematic frequency shifting according to the first preferred embodiment of the present invention. In FIG. 2, the protection and control circuit 11 includes a first current source CS1 of 1 μA receiving the external shutdown signal SDN and a positive power voltage V_{DD}, a zener diode Z1 of 5V having a grounded anode and a cathode coupled to the first current source CS1 and the positive power voltage V_{DD}, an inverter INV1 having an input terminal coupled to the first current source CS1 and the external shutdown signal SDN, an OR gate OR having a first input terminal coupled to the output terminal of the inverter INV1, a second input terminal and an output terminal coupled to the tri-mode clock controller 12 and a over-temperature protection circuit over temp coupled to the second input terminal of the OR gate. The tri-mode clock controller 12 includes a tri-mode circuitry 122 (tri-mode) having a first input terminal receiving a voltage reference V_{REF}, a second input terminal coupled to the PWM controller 13, a third input terminal coupled to the output terminal of the OR gate OR and an output terminal outputting the control signal to control the frequency of the clock signal according to the feedback signal and a system clock 121 (burst-20 KHz-80 KHz clock) receiving the control signal and generating the clock signal to control the timing of the pulse train. In the first preferred embodiment of the present invention, the system clock 121 is a burst-20 KHz-80 KHz clock, and the switching regulator 1 operates at 80 KHz at heavy load, drops back to 20 KHz at light-load, and operates at 20 KHz for a predetermined time and drops the frequency to zero with no-load. The PWM controller 13 includes a second current source of 10 μA CS2, coupled to the feedback signal FB, a diode D1 having an anode coupled to the feedback signal FB and the second current source CS2 and a cathode, a resistor of 100K having a first terminal coupled to the cathode of the diode D1 and a second terminal grounded, a digital soft start circuit (digital soft start) having a first terminal coupled to the first terminal of the resistor and the second input terminal of the tri-mode circuitry and a second terminal, a leading edge blanking operational amplifier (OA) LEB having a first input terminal coupled to the second terminal of the digital soft start circuit, a second input terminal, a third input terminal receiving the clock signal and an output terminal, a slope compensation device having a first terminal coupled to the current sense IS and a second terminal coupled to the second input terminal of the OA LEB and a flip-flop (flip flop) having a first input terminal coupled to the third input terminal of the OA LEB, a second input terminal coupled to the output terminal of the OA LEB, a first output terminal and a second output terminal. In the first preferred embodiment of the present invention, the output driver 14 is a boost driver. The output driver 14 includes a first OA having a first input terminal, a second input terminal coupled to a negative power voltage V_{SS} and a ground, and an output terminal, a second OA having a first input terminal coupled to the first input terminal of the first OA and the first output terminal of the flip-flop, a second input terminal, a third input terminal coupled to the negative power voltage V_{SS} and the ground, and an output terminal coupled to the gate drive GD and a capacitor C1 having a negative terminal CN coupled to the output terminal of the first OA and a positive terminal CP coupled to the second input terminal of the second OA.

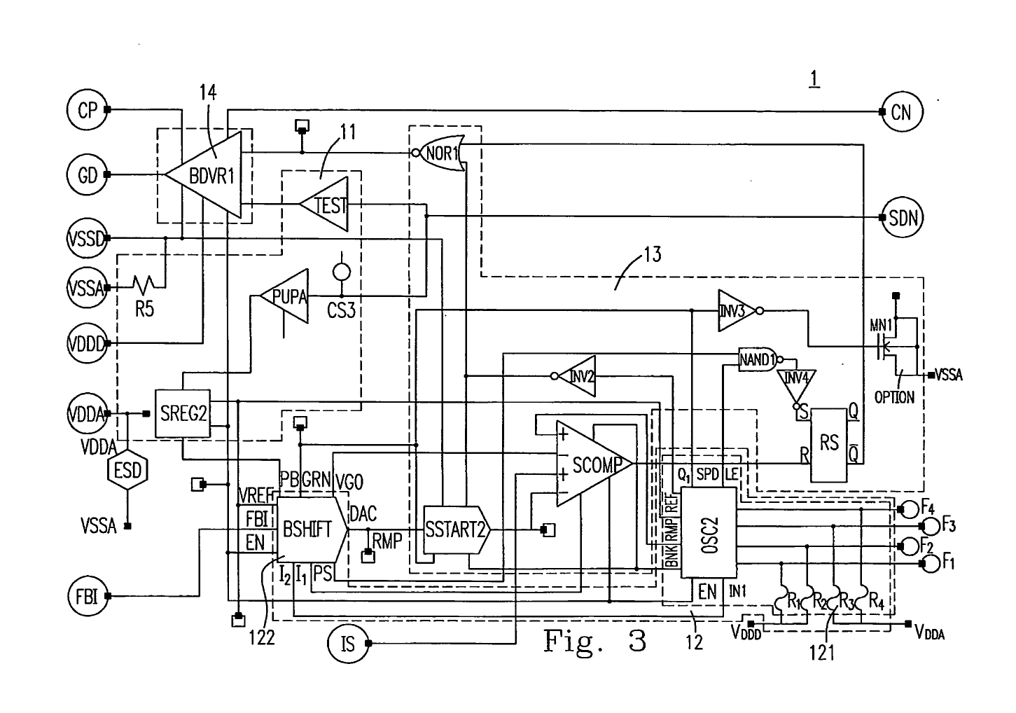

Please refer to FIG. 3, it is a detailed block diagram of the switching regulator 1 having systematic frequency shifting according to the first preferred embodiment of the present invention. In which, the protection and control circuit 11 includes an OA TEST having an input terminal receiving to the shutdown signal SDN and an output terminal, an OA PUPA having a first and a second input terminals and an output terminal, a third current source CS3 coupled to the first input terminal of the OA PUPA, a resistor R5 having a first terminal coupled to a first negative power voltage terminal VSSD and a second terminal coupled to a second negative power voltage terminal VSSA and a shunt regulator SREG2 having a built-in over-temperature protection device, an input terminal coupled to the output terminal of the OA PUPA, a first output terminal outputting a voltage reference V_{REF}, a second output terminal outputting an enable signal and a third output terminal. The tri-mode clock controller 12 includes a system clock 121 having four resistors R1-R4, each of which has a first terminal and a second terminal, and an oscillating device OSC2 having eight terminals Q1, SPD, LE, REF coupled to the first output terminal of SREG2, RMP, BNK, EN coupled to the second output terminal of SREG2 and IN1, and a tri-mode circuitry BSHIFT having 10 terminals PB, GRN coupled to the terminal SPD of OSC2, VGO, VREF coupled to the first output terminal of SREG2, FBI coupled to an external terminal FBI and receiving a feedback signal, EN coupled to the second output terminal of SREG2, 12 coupled to the terminal IN1 of OSC2, I1, PS, and DAC. The first terminals of resistors R1-R4 are coupled to four external terminals F1, F2, F3 and F4 respectively, the second terminals of the resistors R1 and R2 are coupled to the external terminal V_{DDD} for receiving a positive power voltage, and the second terminals of the resistors R3 and R4 are coupled to the external terminal V_{DDA} for receiving the positive power voltage so as to trim the frequency of the oscillating device OSC2. The PWM controller 13 includes a NOR gate NOR1 having a first and a second input terminals and an output terminal, a soft start circuit SSTART2 having a first input terminal coupled to the external terminal VSSD, a second input terminal coupled to the terminal DAC of BSHIFT and an external terminal RMP, a third input terminal coupled to the terminal BNK of OSC2, a first output terminal coupled to the second input terminal of the NOR gate NOR1, and a second and a third output terminals, an inverter INV2 having an input terminal coupled to the terminal Q1 of OSC2 and an output terminal coupled to the first output terminal of SSTART2, a system comparator SCOMP having a first input terminal coupled to the terminal RMP of OSC2, a second input terminal coupled to the terminal VGO of BSHIFT, a third input terminal coupled to an external terminal IS and receiving a current sense signal, a fourth input terminal coupled to the second output terminal of SSTART2, a fifth input terminal coupled to the terminal BNK of OSC2, a sixth input terminal coupled to the terminal I1 of the BSHIFT, a seventh input terminal coupled to the terminal EN of BSHIFT and an output terminal, an inverter INV3 having an input terminal coupled to the third output terminal of SSTART2 and the terminal Q1 of OSC2, and an output terminal, an option (switch) MN1 having a first, a second and a body terminals coupled to one another and receiving a negative power voltage VSSA, and a control terminal coupled to the output terminal of the inverter INV3, a NAND gate NAND1 having a first input terminal coupled to the terminal PS of BSHIFT, a second input terminal coupled to the terminal LE of OSC2 and an output terminal, an inverter INV4 having an input terminal coupled to the output terminal of the NAND Gate NAND1, and a flip-flop RS having a first input terminal coupled to the output terminal of the inverter INV4, a second input terminal coupled to the output terminal of the system comparator SCOMP, a first output terminal coupled to the first input terminal of the NOR gate NOR1 and a second output terminal. The output driver (BDVR1) 14 includes a first input terminal coupled to the output terminal of the NOR gate NOR1, a second input terminal coupled to an external terminal CN connecting to the negative terminal of the capacitor C1 (as shown in FIG. 2), a third input terminal coupled to an external terminal CP connecting to the positive terminal of the capacitor C1, a fourth input terminal coupled to the output terminal of the OA TEST, a fifth input terminal coupled to the second output terminal of SREG2, a sixth input terminal coupled to an external terminal VDDD receiving a positive power voltage, a seventh input terminal coupled to the external terminal VSSD and an output terminal coupled to an external terminal GD for connecting to the gate drive. In FIG. 3, the ESD is an electrostatic discharge protection circuit coupled to an external terminal VSSA for receiving the negative power voltage and coupled to an external terminal VDDA for receiving the positive power voltage.

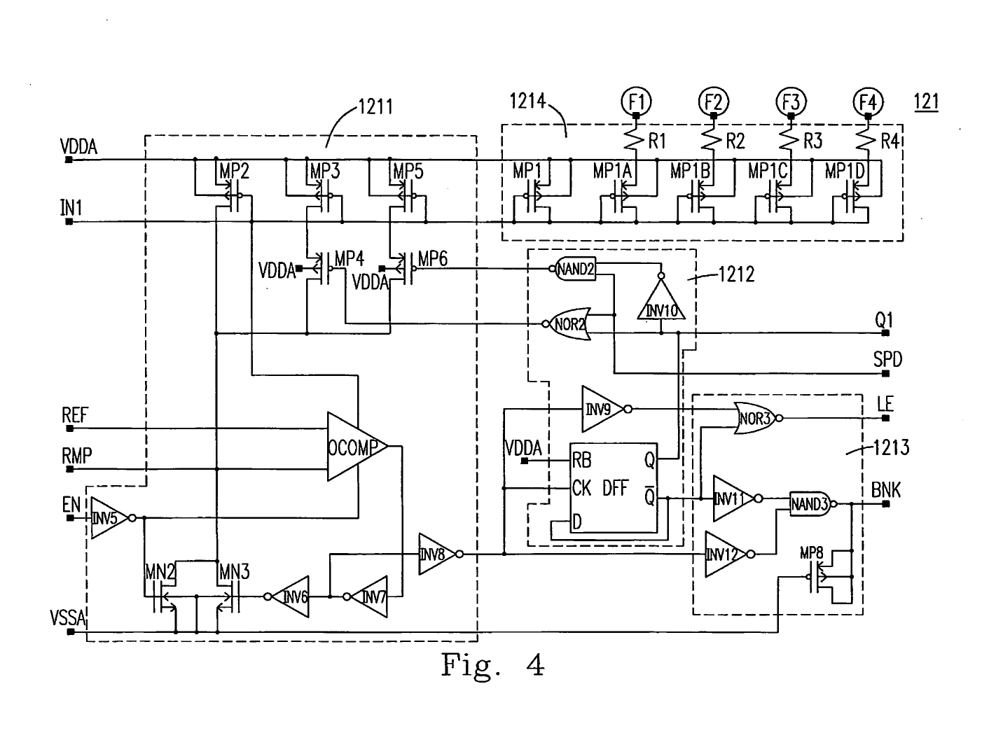

Referring to FIG. 4, which is a system clock with pulse width limiting at the low clock frequency according to the first preferred embodiment of the present invention. In FIG. 4, the system clock 121 includes a dual slope-sawtooth oscillator 1211 generating a sawtooth waveform signal with each odd rising edge having a first slope (fixed) and each even rising edge having a second slope (decided by the first control signal receiving via the terminal SPD), a steering logic circuit 1212 coupled to the dual slope-sawtooth oscillator 1211 and causing the dual slope-sawtooth oscillator 1211 to switch from the first slope to the second slope and vise versa according to the first control signal, a leading edge blanking circuit 1213 coupled to the steering logic circuit 1212 and the dual slope-sawtooth oscillator 1211 and eliminating a spike of the sawtooth waveform signal so as to generate the clock signal and a trimming circuit 1214 coupled to the dual slope-sawtooth oscillator 1211 and trimming the frequency of the clock signal.

Please refer to FIG. 4, the dual slope-sawtooth oscillator 1211 includes a current source having a first to a third switches (MP2, MP3 and MP5) each of which has a first, a second, a control and a body terminals, wherein all of the first and the body terminals of the first to the third switches (MP2, MP3 and MP5) are coupled to a positive power voltage VDDA, and all of the control terminals of the first to the third switches (MP2, MP3 and MP5) are coupled to the tri-mode circuitry 122 via the terminal IN1, a fourth switch MP4 having a first terminal coupled to the second terminal of the second switch MP3, a second terminal coupled to the second terminal of the first switch MP2, a control terminal coupled to steering logic circuit 1212 and a body terminal receiving the positive power voltage VDDA, a fifth switch MP6 having a first terminal coupled to the second terminal of the third switch MP5, a second terminal coupled to the second terminal of the fourth switch MP4, a control terminal coupled to the steering logic circuit 1212 and a body terminal receiving the positive power voltage VDDA, an operational amplifier (OA) OCOMP having a first to a fourth input terminals and an output terminal, wherein the first and the second input terminals of the OA OCOMP receive a voltage reference REF and a slope compensation signal RMP generated by the system comparator SCOMP of the PWM controller 13 (as shown in FIG. 3) respectively, and the third input terminal of the OA OCOMP is coupled to the control terminal of the first switch MP2, an inverter IWV5 having an input terminal receiving an enable signal via the terminal EN and an output terminal coupled to the fourth input terminal of the OA OCOMP, a switch MN2 having a first terminal receiving a negative power voltage VSSA, a second terminal coupled to the second input terminal of the OA OCOMP, a control terminal coupled to the output terminal of the inverter INV5 and a body terminal receiving the negative power voltage VSSA, a switch MN3 having a first terminal receiving the negative power voltage VSSA, a second terminal coupled to the second terminal of the switch MN2, a body terminal receiving the negative power voltage VSSA and a control terminal, an inverter INV6 having an input terminal and an output terminal coupled to the control terminal of the switch MN3, an inverter INV7 having an input terminal coupled to the output terminal of the OA OCOMP and an output terminal coupled to the input terminal of the inverter INV6 and an inverter INV8 having an input terminal coupled to the input terminal of the inverter INV6 and an output terminal generating the sawtooth waveform signal.

Referring to FIG. 4, the steering logic circuit 1212 includes a NAND gate NAND2 having a first input terminal, a second input terminal and an output terminal coupled to the control terminal of the switch MP6 of the dual slope-sawtooth oscillator 1211 and generating a second control signal, a NOR gate NOR2 having a first input terminal coupled to the second input terminal of the NAND gate NAND2 and receiving the first control signal via the terminal SPD, a second input terminal and an output terminal coupled to the control terminal of the switch MP4 of the dual slope-sawtooth oscillator 1211 and generating a third control signal, an inverter INV10 having an input terminal coupled to the second input terminal of the NOR gate NOR2 and the input terminal of the inverter INV2 of the PWM controller 13 via the terminal Q1 (as shown in FIG. 3) and an output terminal coupled to the first input terminal of the NAND gate NAND2, an inverter INV9 having an input terminal receiving the sawtooth waveform signal and an output terminal coupled to the leading edge blanking circuit 1213 and a flip-flop DFF having a first input terminal receiving a positive power voltage VDDA, a second input terminal receiving the sawtooth waveform signal and coupled to the input terminal of the inverter INV9, a third input terminal, a first output terminal coupled to the input terminal of the inverter INV10 and outputting a second pulse signal and a second output terminal coupled to the third input terminal of the flip-flop DFF and the leading edge blanking circuit 1213, and outputting a third pulse signal.

In FIG. 4, the leading edge blanking circuit 1213 includes a NOR gate NOR3 having a first input terminal coupled to the output terminal of the inverter INV9 of the steering logic circuit 1212, a second input terminal and an output terminal coupled to the second input terminal of the NAND gate NAND1 of the PWM controller 13 via the terminal LE (as shown in FIG. 3) and outputting a leading edge signal, an inverter INV11 having an input terminal coupled to the second input terminal of the NOR gate NOR3 and the second output terminal of the flip-flop DFF of the steering logic circuit 1212, and an output terminal, an inverter INV12 having an input terminal coupled to the second input terminal of the flip-flop DFF of the steering logic circuit 1212 and the output terminal of the inverter INV8 of the dual slope-sawtooth oscillator 1211, and receiving the sawtooth waveform signal, and an output terminal, a NAND gate NAND3 having a first input terminal coupled to the output terminal of the inverter INV11, a second input terminal coupled to the output terminal of the inverter INV12 and an output terminal coupled to the third input terminal of SSTART2 of the PWM controller 13 (as shown in FIG. 3) and outputting a blanking signal via terminal BNK, and a switch MP8 having a first, a second, a control and a body terminals, wherein the control terminal of the switch MP8 is coupled to a negative power voltage VSSA, and the first, the second and the body terminals of the switch MP8 are coupled to the output terminal of the NAND gate NAND3.

Please refer to FIG. 4, the trimming circuit 1214 includes a first to a fifth switches MP1, MP1A, MP1B, MP1C and MP1D, each of which has a first, a second, a control and a body terminals, wherein all of the body terminals of the first to the fifth switches MP1, MP1A, MP1B, MP1C and MP1D and the first terminal of the first switch MP1 are coupled to a positive power voltage VDDA, and all of the second terminals of the first to the fifth switches MP1, MP1A, MP1B, MP1C and MP1D are coupled to the tri-mode circuitry 122 via the terminal IN1 (as shown in FIG. 3), a first to a fourth resistors R1-R4, each of which has a first and a second terminals, wherein all of the first terminals of the first to the fourth resistors R1-R4 are coupled to the first terminals of the second to the fifth switches MP1A, MP1B, MP1C and MP1D respectively, and the second terminals of the first to the fourth resistors R1-R4 are coupled to a first to a fourth external terminals F1-F4 respectively for trimming the frequency of the clock signal.

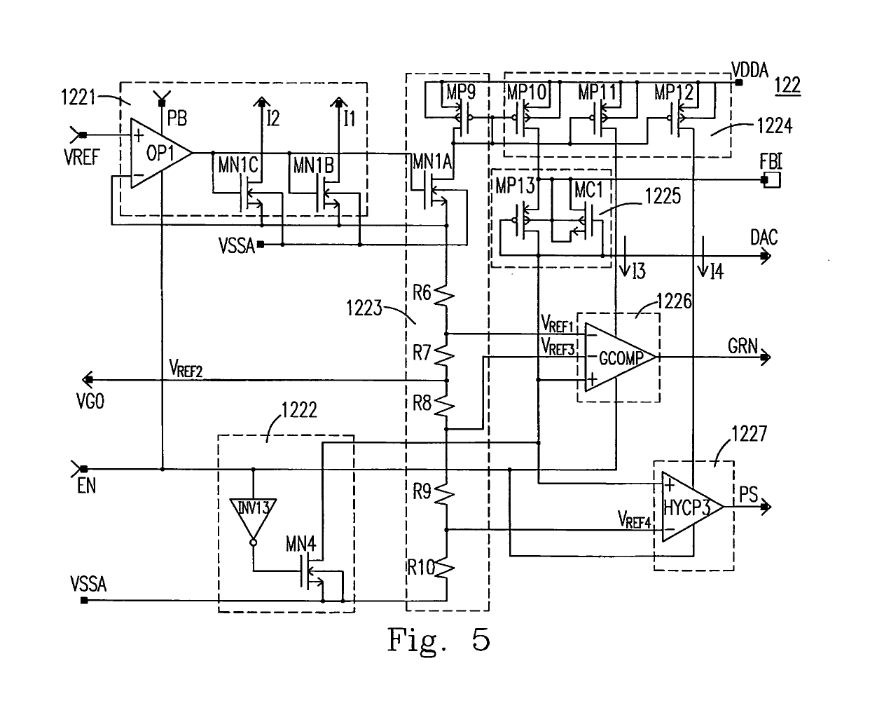

Referring to FIG. 5, which is a circuit for recognizing when to shift the frequency, up, or down according to the first preferred embodiment of the present invention. As aforementioned, the SREG2 of the protection and control circuit 11 outputs the enable signal via the terminal EN and outputs the voltage reference via the terminals VREF/REF etc. as shown in FIG. 3, wherein the enable signal is active when the shutdown signal is inactive. In FIG. 5, the tri-mode circuitry 122 includes a first current source 1221 receiving the voltage reference VREF and a negative power voltage VSSA, and generating a first and a second currents I1 and I2, a second current source 1224 receiving the feedback signal via the terminal FBI and a positive power voltage VDDA, and generating a third and a fourth currents I3 and I4, a reference string circuit 1223 coupled to the first and the second current sources 1221 and 1224, receiving the positive and negative power voltages VDDA and VSSA and generating a first to a fourth reference voltages V_{REF1}-V_{REF4}, a voltage level shifting circuit 1225 receiving the feedback signal via the terminal FBI, coupled to the second current source 1224 and providing a level shifting of voltage when the tri-mode circuitry 122 switches from the light-load mode to the heavy-load mode and vise versa, a light-load mode/heavy-load mode detector 1226 coupled to the voltage level shifting circuit 1225, receiving the third current I3, the first and the third reference voltages V_{REF1} and V_{REF3} and the enable signal, and generating the first control signal via the terminal GRN, a no-load mode control circuit 1227 coupled to the light-load mode/heavy-load mode detector 1226, receiving the fourth current I4, the fourth reference voltage V_{REF4} and the enable signal, and generating a second control signal via the terminal PS, and an enable circuit 1222 receiving the enable signal via the terminal EN and the negative power voltage VSSA and coupled to the no-load mode control circuit 1227, wherein the voltage level shifting circuit 1225, the light-load mode/heavy-load mode detector 1226 and the no-load mode control circuit 1227 are grounded via the enable circuit 1222 when the enable signal is inactive such that the switching regulator 1 is shut down, and the PWM controller 13 receives the second reference voltage V_{REF2} via the terminal VGO.

Please refer to FIG. 5, the first current source 1221 includes an OA OP1 having a first input terminal receiving the voltage reference VREF generated by the protection and control circuit 11, a second input terminal, a third input terminal coupled to the protection and control circuit 11 via the terminal PB (as shown in FIG. 3), a fourth input terminal coupled to the enable circuit 1222 and an output terminal, and two switches MN1B and MN1C, each of which has a first, a second, a control and a body terminals, wherein all of the first terminals of the two switches MN1B and MN1C are coupled to the second input terminal of the OA OP1, all of the control terminals of the two switches MN1B and MN1C are coupled to the output terminal of the OA OP1, the second terminal of the switch MN1B outputs a first current I1, the second terminal of the switch MN1C outputs a second current I2, and all of the body terminals of the two switches WN1B and MN1C receive a negative power voltage VSSA.

Referring to FIG. 5, the second current source 1224 includes three switches MP10-MP12, each of which has a first, a second, a control and a body terminals, wherein all of the first and the body terminals of the three switches MP10-MP12 are coupled to a positive power voltage VDDA, all of the control terminals of the three switches MP10-MP12 are coupled to the reference string circuit 1223, the second terminal of the switch MP10 is coupled to the voltage level shifting circuit 1225, the second terminal of the switch MP11 is coupled to the light-load mode/heavy-load mode detector 1226, and the second terminal of the switch MP12 is coupled to the no-load mode control circuit 1227.

In FIG. 5, the reference string circuit 1223 includes a switch MP9 having a first, a second, a control and a body terminals, wherein the first and the body terminals of the switch MP9 are coupled to the positive power voltage VDDA, and the control terminal of the switch MP9 is coupled to the control terminal of the switch MN10 of the second current source 1224, a switch MN1A having a first, a second, a control and a body terminals, wherein the second terminal of the switch MN1A is coupled to the second terminal of the switch MP9, and the first, the control and the body terminals of the switch MN1A are coupled to the first current source 1221, five resistors R6-R10, each of which has a first and a second terminals, wherein the resistors R6-R10 are electrically connected in series, the first terminal of the resistor R6 is coupled to the first terminal of the switch MN1A, the second terminal of the resistor R6 and the second terminal of the resistor R8 are both coupled to the light-load mode/heavy-load mode detector 1226 and output the first and the third reference voltages V_{REF1} and V_{REF3} respectively, the second terminal of the resistor R7 is coupled to the PWM controller 13 via the terminal VGO and outputs the second reference voltage V_{REF2}, the second terminal of the resistor R9 is coupled to the no-load mode control circuit 1227 and outputs the fourth reference voltage V_{REF4}, and the second terminal of the resistor R10 receives a negative power voltage VSSA and is coupled to the enable circuit 1222.

Please refer to FIG. 5, the voltage level shifting circuit 1225 includes two switches MP13 and MC1, each of which has a first, a second, a control and a body terminals, wherein all of the first and the body terminals of the two switches MP13 and MC1, and the second terminal of the switch MC1 are coupled to the second current source 1224, and all of the control terminals of the two switches MP13 and MC1 and the second terminal of the switch MP13 are coupled to one another and to the enable circuit 1222, the light-load mode/heavy-load mode detector 1226 and the no-load mode control circuit 1227.

Referring to FIG. 5, the light-load mode/heavy-load mode detector 1226 is an OA GCOMP having a first to a fifth input terminals and an output terminal, wherein the first and the second input terminals of the OA GCOMP are coupled to the reference string circuit 1223 and receive the first and the third reference voltages V_{REF1} and V_{REF3} respectively, the third input terminal of the OA is coupled to the voltage level shifting circuit 1225, the enable circuit 1222 and the no-load mode control circuit 1227, the fourth input terminal is coupled to the second current source 1224, the fifth input terminal is coupled to the enable circuit 1222 and the no-load mode control circuit 1227, and the output terminal is coupled to the PWM controller 13 and the system clock 121.

In FIG. 5, the no-load mode control circuit 1227 is an OA HYCP3 having a first to a fourth input terminals and an output terminal, wherein the first input terminal of the OA HYCP3 is coupled to the voltage level shifting circuit 1225, the enable circuit 1222 and the light-load mode/heavy-load mode detector 1226, the second input terminal of the OA HYCP3 is coupled to the reference string circuit 1223 and receives the fourth reference voltage V_{REF4}, the third input terminal of the OA HYCP3 is coupled to the second current source 1224, the fourth input terminal of the OA HYCP3 is coupled to the enable circuit 1222 and the light-load mode/heavy-load mode detector 1226, and the output terminal of the OA HYCP3 is coupled to the PWM controller 13 via the terminal PS.

Please refer to FIG. 5, the enable circuit 1222 includes an inverter INV 13 having an input terminal receiving the enable signal via the terminal EN, and coupled to the light-load mode/heavy-load mode detector 1226 and the no-load mode control circuit 1227, and an output terminal and a switch MN4 having a first, a second, a control and a body terminals, wherein the second terminal of the switch MN4 is coupled to the voltage level shifting circuit 1225, the light-load mode/heavy-load mode detector 1226 and the no-load mode control circuit 1222, the first and the body terminals of the switch MN4 receive a negative power voltage VSSA, and the control terminal of the switch MN4 is coupled to the output terminal of the inverter INV13.

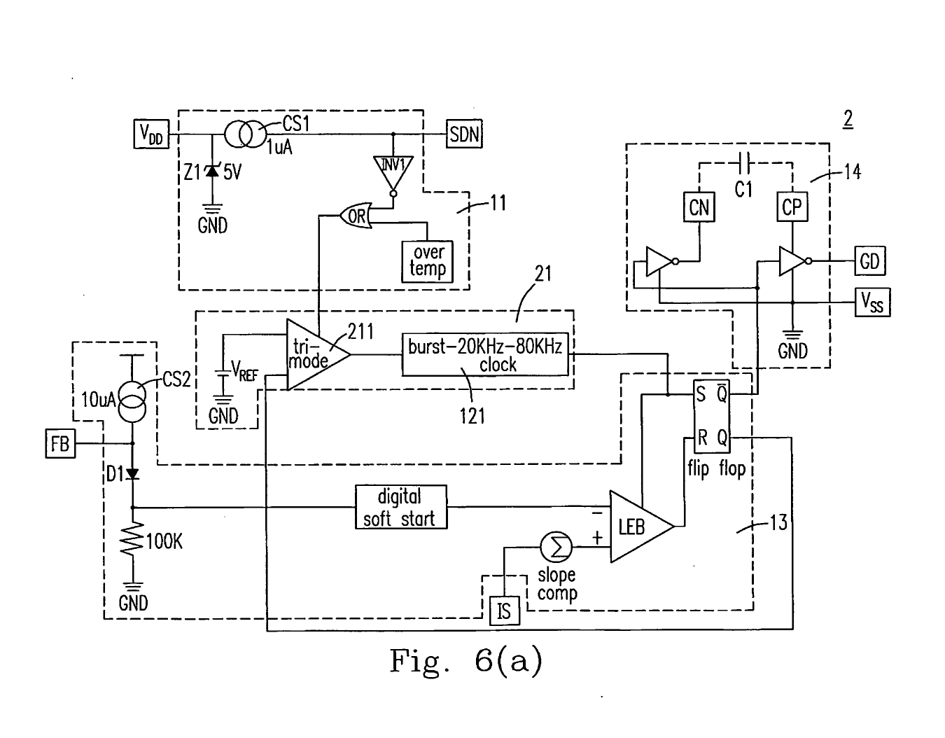

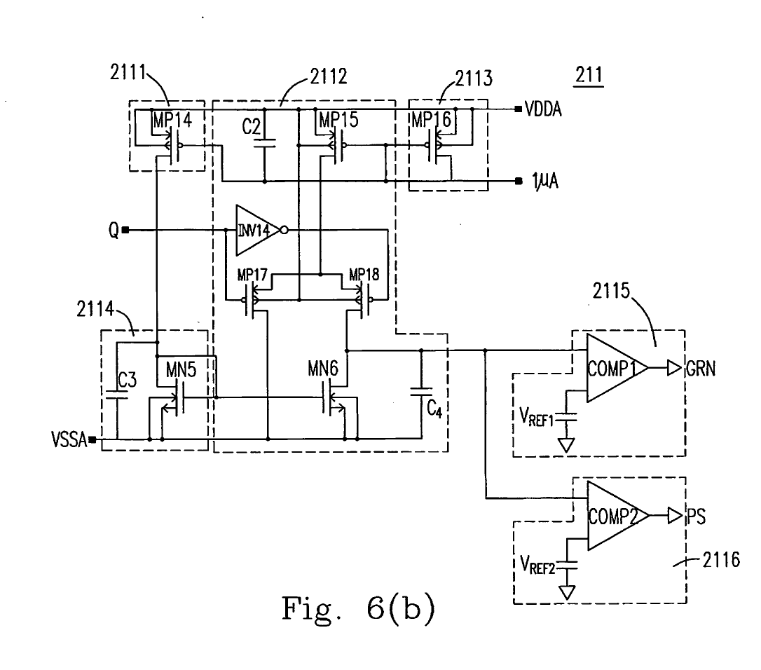

Referring to FIG. 6(a), which is a simplified block diagram of a switching regulator having systematic frequency shifting according to the second preferred embodiment of the present invention. In FIG. 6(a), the provided switching regulator 2 has almost the same configuration as that of the switching regulator 1 (as shown in FIG. 2) except that the tri-mode circuitry 211 (tri-mode) of the tri-mode clock controller 21 is different from the tri-mode circuitry 122 of the switching regulator 1, and the second input terminal of the tri-mode circuitry 211 receives a first pulse signal output by the second output terminal of the flip-flop (flip flop) instead of a feedback signal of the output voltage across the external load as is the case of FIG. 2.

Please refer to FIG. 6(a), the switching regulator 2 includes a PWM controller 13 generating a first pulse train and a first pulse signal, an output driver 14 receiving the first pulse train and generating a driving signal so as to turn an external switch (not shown) on/off, and a tri-mode clock controller 21 including a system clock 121 generating a clock signal to control a timing of the first pulse train and a tri-mode circuitry 211 detecting whether the first pulse signal is a narrow pulse and generating a first control signal to control a frequency of the clock signal accordingly, wherein the switch operates under a relatively low frequency when the tri-mode circuitry 211 operates at a light-load mode, the switch operates under a relatively high frequency when the tri-mode circuitry 211 operates at a heavy-load mode, and the switch operates at the relatively low frequency for a pre-determined period of time and then turns off when the tri-mode circuitry 211 operates at a no-load mode.

Referring to FIG. 6(a), the tri-mode circuitry 211 operates under the heavy-load mode while the narrow pulse is absent, indicating a relatively heavier external load, such that the frequency of the clock signal switches to a relatively high frequency accordingly, the tri-mode circuitry 211 operates under the light-load mode while the narrow pulse is detected, indicating a relatively lighter external load, such that the frequency of the clock signal switches to a relatively low frequency accordingly, and the tri-mode circuitry 211 operates under the no-load mode while the narrow pulse is detected and is relatively very narrow, indicating the external load is absent, such that the frequency of the clock signal switches to the relatively low frequency for a pre-determined period of time and then drops to zero accordingly.

In FIG. 6(b), it is a scheme for detecting narrow pulses according to the second preferred embodiment of the present invention. The proposed tri-mode circuitry 211 is a pulse width detector, and includes an averaging circuit 2112 receiving the first pulse signal from the PWM 13 via the terminal Q and generating an average value of the first pulse signal, a first to a third current bias circuits 2111, 2113 and 2114 coupled to the averaging circuit 2112 and providing a first to a third current biases to the averaging circuit 2112, a light-load mode/heavy-load mode detector 2115 receiving the averaging value and a first reference voltage V_{REF1} and generating the first control signal and a no-load mode control circuit 2116 receiving the averaging value and a second reference voltage V_{REF2} and generating the second control signal, wherein the narrow pulse is detected and the first control signal is inactive when the average value drops below the first voltage reference V_{REF1}, the narrow pulse is absent and the first control signal is active when the average value is larger than the first voltage reference V_{REF1}, and the narrow pulse is relatively very narrow and the second control signal is active when the average value drops below the second voltage reference V_{REF2}.

Please refer to FIG. 6(b), the averaging circuit 2112 includes two capacitors C2 and C4, each of which has a first and a second terminals, four switches MP15, MP17-MP18 and MN6 and an inverter INV14 having an input and an output terminals, the three current bias circuits 2111, 2113 and 2114 includes three switches MP14, MP16 and MN5 respectively, each of the seven switches MP14-MP18 and MN5-MN6 includes a first, a second, a control and a body terminals, the current bias circuit 2114 further comprises a capacitor C3 having a first and a second terminals, all of the first and the body terminals of the three switches MP14-MN16, the body terminals of the two switches MP17-MP18 and the first terminal of the capacitor C2 are coupled to a positive power voltage VDDA, all of the control terminals of the three switches MP14-MP16 and the second terminal of the capacitor C2 are coupled to an external current source of 1 μA, all of the first and the body terminals of the two switches MN5 and MN6, the second terminal of the switch MP17 and the second terminal of the capacitor C3 are coupled to a negative power voltage VSSA, the second and the control terminals of the switch MN5 and the first terminal of the capacitor C3 are coupled to the second terminal of the switch MP14, the input terminal of the inverter INV14 is coupled to the control terminal of the switch MP17 and receives the first pulse signal, the output terminal of the inverter INV14 is coupled to the control terminal of the switch MP18, the first terminals of the two switches MP17-MP18 are coupled to the second terminal of the switch MP15, the second terminal of the switch MP18 is coupled to the second terminal of the switch MN6, the first and second terminals of the capacitor C4 are coupled to the second terminal of the switch MN6 and the negative power voltage VSSA respectively, the light-load mode/heavy-load mode detector 2115 is a comparator COMP1, and the no-load mode control circuit 2116 is a comparator COMP2.

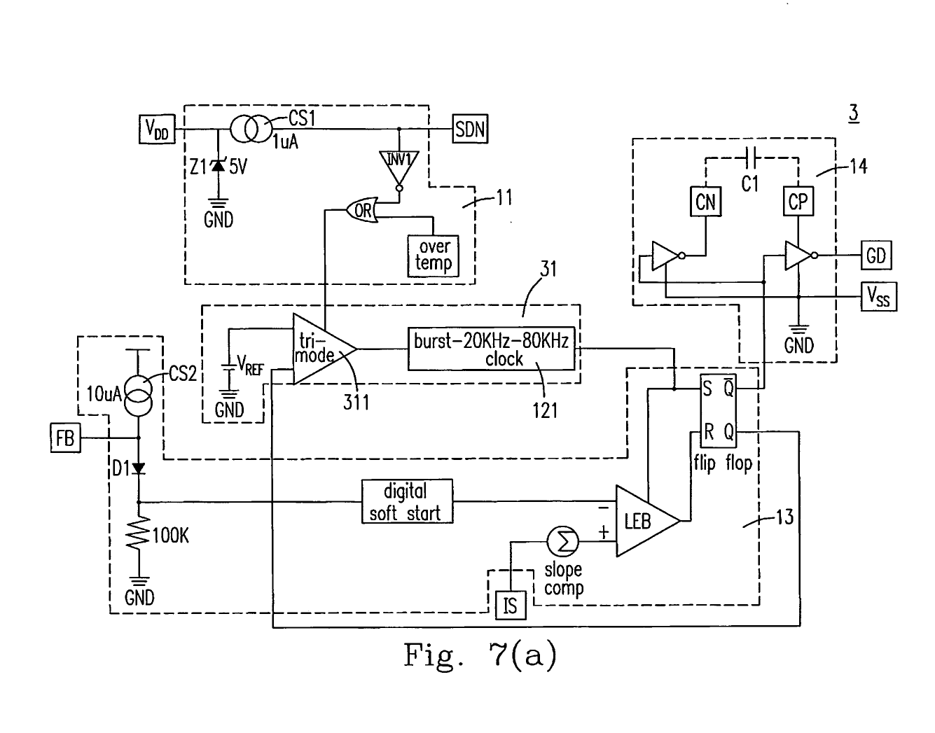

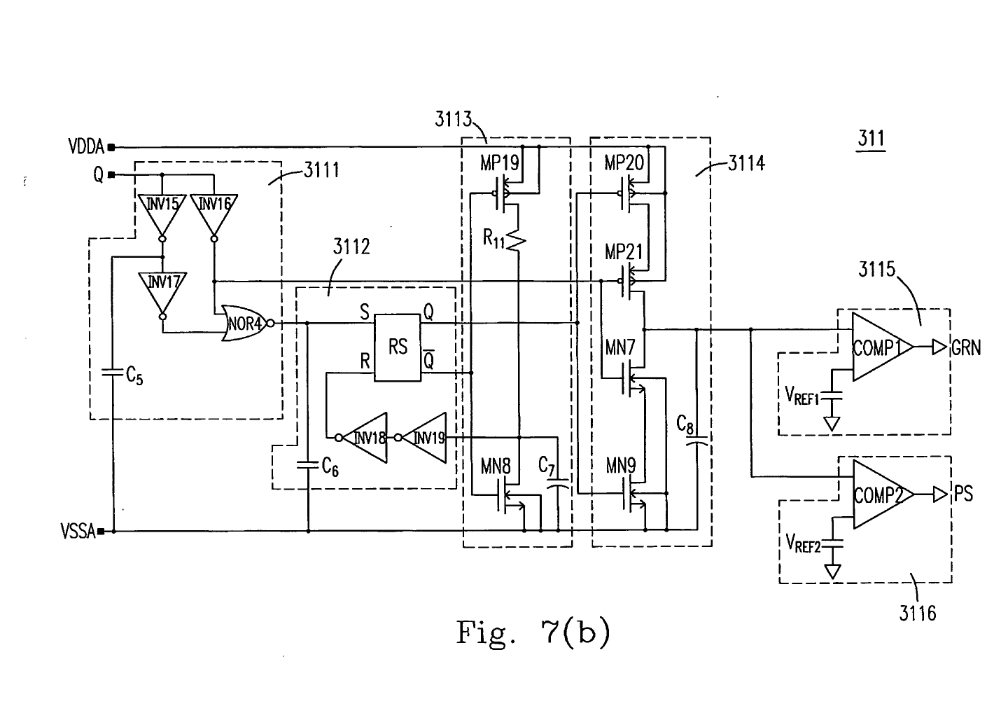

Referring to FIG. 7(a), which is a simplified block diagram of a switching regulator having systematic frequency shifting according to the third preferred embodiment of the present invention. In FIG. 7(a), the provided switching regulator 3 has almost the same configuration as that of the switching regulator 2 (as shown in FIG. 6(A)) except that the tri-mode circuitry 311 (tri-mode) of the tri-mode clock controller 31 is different from the tri-mode circuitry 211 of the switching regulator 2, and the second input terminal of the tri-mode circuitry 311 also receives a first pulse signal output by the second output terminal of the flip-flop (flip flop) as is the case of FIG. 6(a).

In FIG. 7(b), it is an alternate scheme for detecting narrow pulses according to the third preferred embodiment of the present invention. Please refer to FIG. 7(b), the tri-mode circuitry 311 is a narrow pulse detector, and includes a setting/resetting circuit 3111 receiving a first pulse signal from the PWM controller 13 via the terminal Q and generating a setting/resetting signal, a reference pulse generator 3113 generating a reference pulse, a comparison circuit 3112 including an analog amplifier having two inverters INV18 and INV19 electrically connected in series, receiving the reference pulse and generating an amplified reference pulse and a latch RS receiving the setting/resetting signal and the amplified reference pulse and generating a second pulse train and a second pulse signal, wherein the latch RS is setting and resetting on a leading edge of the first pulse signal according to the setting/resetting signal, and the reference pulse generator 3113 receives the second pulse train and adjusts the reference pulse accordingly and an output circuit 3114 receiving the second pulse signal and generating an output signal accordingly, wherein the output signal increases in voltage if the first pulse signal is larger than the reference pulse, a light-load mode/heavy-load mode detector 3115 receiving the output signal and a Ifirst reference voltage V_{REF1} and generating the first control signal and a no-load mode control circuit 3116 receiving the output signal and a second reference voltage V_{REF2} and generating the second control signal, wherein the narrow pulse is detected and the first control signal is inactive when the output signal drops below the first voltage reference V_{REF1}, the narrow pulse is absent and the first control signal is active when the output signal is larger than the first voltage reference V_{REF1}, and the narrow pulse is relatively very narrow and the second control signal is active when the output signal drops below the second voltage reference V_{REF2}.

Please refer to FIG. 7(b), the setting/resetting circuit 3111 includes three inverters INV15-INV17, each of which has an input and an output terminals, a NOR gate NOR4 having a first and a second input terminals and an output terminal and a capacitor C5 having a first and a second terminals, the input terminals of the two inverters INV15-INV16 receiving the first pulse signal, the output terminal of the inverter INV15 and the first terminal of the capacitor C5 coupled to the input terminal of the third inverter INV17, the output terminal of the inverter INV16 coupled to the first input terminal of the NOR gate NOR4, the output terminal of the inverter INV17 coupled to the second input terminal of the NOR gate NOR4, the output terminal of the NOR gate NOR4 generating the setting/resetting signal, the comparison circuit 3112 further comprises a capacitor C6 having a first and a second terminals, the analog amplifier (INV18+INV19) having an input and an output terminals, the latch RS includes a first input terminal coupled to the output terminal of the NOR gate NOR4 and the first terminal of the capacitor C6, a second input terminal coupled to the output terminal of the analog amplifier (output terminal of INV18) and a first and a second output terminals, the reference pulse generator 3113 includes two switches MP19 and MN8, a resistor R11 having a first and a second terminals and capacitor C7 having a first and a second terminals, the output circuit 3114 includes four switches MP20, MP21, MN7 and MN9 and a capacitor C8 having a first and a second terminals, each of the six switches MP19-MP21 and MN7-MN9 having a first, a second, a control and a body terminals, all of the first and the body terminals of the two switches MP19-MP20 are coupled to a positive power voltage VDDA, all of the first and the body terminals of the two switches MN8-MN9 and the second terminals of the four capacitors C5-C8 are coupled to a negative power voltage VSSA, the second terminal of the switch MP19 is coupled to the first terminal of the resistor R11, the second terminal of the resistor R11 is coupled to the input terminal of the analog amplifier (input terminal of INV19), the second terminal of the switch MN8 and the first terminal of the capacitor C7, the control terminal of the switch MP19 is coupled to the second output terminal of the latch RS and the control terminal of the switch MN8, the control terminal of the switchMP20 is coupled to the first output terminal of the latch RS and the control terminal of the switch MN9, the second terminal of the switch MP20 is coupled to the first terminal of the switch MP21, the body terminal of the switch MP21 is coupled to the body terminal of the switch MP20, the second terminal of the switch MP21 is coupled to the second terminal of the switch MN7 and the first terminal of the capacitor C8 and generates the output signal, the body terminal of the switch MN7 is coupled to the body terminal of the switch MN9, and the first terminal of the switch MN7 is coupled to the second terminal of the switch MN9.

One unique feature of the present invention is that the maximum on-time of the PWM controller 13 is always kept the same no matter the external switch is operating under a relatively low frequency, a relatively high frequency, or a no-load mode/burst mode.

In conclusion, the present invention provides a high efficiency switching regulator over a broad current range while maintaining excellent output regulation and minimal interference.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims, which are to be accorded with the broadest interpretation so as to encompass all such modifications and similar structures. Therefore, the above description and illustration should not be taken as limiting the scope of the present invention which is defined by the appended claims.

What is claimed is:

1. A switching regulator, comprising:
a pulse-width modulation (PWM) controller generating a pulse train;
an output driver receiving the pulse train and generating a driving signal so as to turn an external switch on/off; and
a tri-mode clock controller generating a clock signal to control a timing of the pulse train, receiving a feedback signal of an output voltage across an external load and generating a first control signal to control a frequency of the clock signal according to the feedback signal.

2. A switching regulator according to claim 1, wherein the tri-mode clock controller comprises a system clock generating the clock signal and a tri-mode circuitry receiving the feedback signal and generating the first control signal, the switch operates under a relatively low frequency when the tri-mode clock controller operates under a light-load mode, the switch operates under a relatively high frequency when the tri-mode circuitry operates under a heavy-load mode, and the switch operates under the relatively low frequency for a pre-determined period of time and then turns off when the tri-mode circuitry operates under a no-load mode, the tri-mode circuitry operates under the heavy-load mode while the feedback signal is relatively high, indicating a relatively heavier external load, such that the frequency of the clock signal is switched to the relatively high frequency, the tri-mode circuitry operates under the light-load mode while the feedback signal is relatively low, indicating a relatively lighter external load, such that the frequency of the clock signal is switched to the relatively low frequency, and the tri-mode circuitry operates under the no-load mode while the feedback signal equals to zero, indicating that the external load is absent such that the frequency of the clock signal is switched to the relatively low frequency for a pre-determined period of time and then drops to zero.

3. A switching regulator according to claim 2, wherein the system clock comprises:
a dual slope-sawtooth oscillator generating a sawtooth waveform signal with each odd rising edge having a first slope and each even rising edge having a second slope;
a steering logic circuit coupled to the dual slope-sawtooth oscillator and causing the dual slope-sawtooth oscillator to switch from the first slope to the second slope and vise versa according to the first control signal;
a leading edge blanking circuit coupled to the steering logic circuit and the dual slope-sawtooth oscillator and eliminating a spike of the sawtooth waveform signal so as to generate the clock signal; and
a trimming circuit coupled to the dual slope-sawtooth oscillator and trimming the frequency of the clock signal.

4. A switching regulator according to claim 3, wherein the dual slope-sawtooth oscillator comprises:
a current source having a first to a third switches, each of which has a first, a second, a control and a body terminals, wherein all of the first and the body terminals of the first to the third switches are coupled to a positive power voltage, and all of the control terminals of the first to the third switches are coupled to the tri-mode circuitry;
a fourth switch having a first terminal coupled to the second terminal of the second switch, a second terminal coupled to the second terminal of the first switch, a control terminal coupled to the steering logic circuit and a body terminal receiving the positive power voltage;
a fifth switch having a first terminal coupled to the second terminal of the third switch, a second terminal coupled to the second terminal of the fourth switch, a control terminal coupled to the steering logic circuit and a body terminal receiving the positive power voltage;
an operational amplifier (OA) having a first to a fourth input terminals and an output terminal, wherein the first and the second input terminals of the OA receive a voltage reference and a slope compensation signal generated by the PWM controller respectively, and the third input terminal of the OA is coupled to the control terminal of the first switch;
a first inverter having an input terminal receiving an enable signal and an output terminal coupled to the fourth input terminal of the OA;
a sixth switch having a first terminal receiving a negative power voltage, a second terminal coupled to the second input terminal of the OA, a control terminal coupled to the output terminal of the first inverter and a body terminal receiving the negative power voltage;
a seventh switch having a first terminal receiving the negative power voltage, a second terminal coupled to the second terminal of the sixth switch, a body terminal receiving the negative power voltage and a control terminal;
a second inverter having an input terminal and an output terminal coupled to the control terminal of the seventh switch;
a third inverter having an input terminal coupled to the output terminal of the OA and an output terminal coupled to the input terminal of the second inverter; and
a fourth inverter having an input terminal coupled to the input terminal of the second inverter and an output terminal generating the sawtooth waveform signal.

5. A switching regulator according to claim 3, wherein the steering logic circuit comprises:
a NAND gate having a first input terminal, a second input terminal and an output terminal coupled to the dual slope-sawtooth oscillator and generating a second control signal;
a NOR gate having a first input terminal coupled to the second input terminal of the NAND gate and receiving the first control signal, a second input terminal and an output terminal coupled to the dual slope-sawtooth oscillator and generating a third control signal;
a first inverter having an input terminal coupled to the second input terminal of the NOR gate and the PWM controller, and an output terminal coupled to the first input terminal of the NAND gate;
a second inverter having an input terminal receiving the sawtooth waveform signal and an output terminal coupled to the leading edge blanking circuit; and
a flip-flop having a first input terminal receiving a positive power voltage, a second input terminal receiving the sawtooth waveform signal and coupled to the input terminal of the second inverter, a third input terminal, a first output terminal coupled to the input terminal of the first inverter and outputting a second pulse signal and a second output terminal coupled to the third input terminal of the flip-flop and the leading edge blanking circuit, and outputting a third pulse signal.

6. A switching regulator according to claim 3, wherein the leading edge blanking circuit comprises:
a NOR gate having a first input terminal coupled to the steering logic circuit, a second input terminal and an output terminal coupled to the PWM controller and outputting a leading edge signal;
a first inverter having an input terminal coupled to the second input terminal of the NOR gate and the steering logic circuit, and an output terminal;
a second inverter having an input terminal coupled to the steering logic circuit and the dual slope-sawtooth oscillator, and receiving the sawtooth waveform signal, and an output terminal;
a NAND gate having a first input terminal coupled to the output terminal of the first inverter, a second input terminal coupled to the output terminal of the second inverter and an output terminal coupled to the PWM controller and outputting a blanking signal; and
a switch having a first, a second, a control and a body terminals,
wherein the control terminal of the switch is coupled to a negative power voltage, and the first, the second and the body terminals of the switch are coupled to the output terminal of the NAND gate.

7. A switching regulator according to claim 3, wherein the trimming circuit comprises:
a first to a fifth switches, each of which has a first, a second, a control and a body terminals, wherein all of the body terminals of the first to the fifth switches and the first terminal of the first switch are coupled to a positive power voltage, and all of the second terminals of the first to the fifth switches are coupled to the tri-mode circuitry;
a first to a fourth resistors, each of which has a first and a second terminals,
wherein all of the first terminals of the first to the fourth resistors are coupled to the first terminals of the second to the fifth switches respectively, and the second terminals of the first to the fourth resistors are coupled to a first to a fourth external terminals respectively for trimming the frequency of the clock signal.

8. A switching regulator according to claim 2, further comprising a protection and control circuit protecting the switching regulator from an over-temperature, shutting the switching regulator down via a shutdown signal input by a user and outputting an enable signal and a voltage reference, wherein the enable signal is active when the shutdown signal is inactive, and the tri-mode circuitry comprises:
a first current source receiving the voltage reference and a negative power voltage, and generating a first and a second currents;
a second current source receiving the feedback signal and a positive power voltage, and generating a third and a fourth currents;
a reference string circuit coupled to the first and the second current sources, receiving the positive and negative power voltages and generating a first to a fourth reference voltages;
a voltage level shifting circuit receiving the feedback signal, coupled to the second current source and providing a level shifting of voltage when the tri-mode circuitry switches from the light-load mode to the heavy-load mode and vise versa;
a light-load mode/heavy-load mode detector coupled to the voltage level shifting circuit, receiving the third current, the first and the third reference voltages and the enable signal, and generating the first control signal;
a no-load mode control circuit coupled to the light-load mode/heavy-load mode detector, receiving the fourth current, the fourth reference voltage and the enable signal, and generating a second control signal; and
an enable circuit receiving the enable signal and the negative power voltage and coupled to the no-load mode control circuit,
wherein the voltage level shifting circuit the light-load mode/heavy-load mode detector and the no-load mode control circuit are grounded via the enable circuit when the enable signal is inactive such that the switching regulator is shut down, and the PWM controller receives the second reference voltage.

9. A switching regulator according to claim 8, wherein the first current source comprises:
an OA having a first input terminal receiving a voltage reference generated by the protection and control circuit, a second input terminal, a third input terminal coupled to the protection and control circuit, a fourth input terminal coupled to the enable circuit and an output terminal; and
a first and a second switches, each of which has a first, a second, a control and a body terminals,
wherein all of the first terminals of the first and the second switches are coupled to the second input terminal of the OA, all of the control terminals of the first and the second switches are coupled to the output terminal of the OA, the second terminal of the first switch outputs a first current, the second terminal of the second switch outputs a second current, and all of the body terminals of the first and the second switches receive a negative power voltage.

10. A switching regulator according to claim 8, wherein the second current source comprises:
a first to a third switches, each of which has a first, a second, a control and a body terminals,
wherein all of the first and the body terminals of the first to the third switches are coupled to a positive power voltage, all of the control terminals of the first to the third switches are coupled to the reference string circuit, the second terminal of the first switch is coupled to the voltage level shifting circuit, the second terminal of the second switch is coupled to the light-load mode/heavy-load mode detector, and the second terminal of the third switch is coupled to the no-load mode control circuit.

11. A switching regulator according to claim 8, wherein the reference string circuit comprises:
a first switch having a first, a second, a control and a body terminals, wherein the first and the body terminals of the first switch are coupled to a positive power voltage, and the control terminal of the first switch is coupled to the second current source;
a second switch having a first, a second, a control and a body terminals, wherein the second terminal of the second switch is coupled to the second terminal of the first switch, and the first, the control and the body terminals of the second switch are coupled to the first current source;
a first to a fifth resistors, each of which has a first and a second terminals,
wherein the first to the fifth resistors are electrically connected in series, the first terminal of the first resistor is coupled to the first terminal of the second switch, the second terminal of the first resistor and the second terminal of the third resistor are both coupled to the light-load mode/heavy-load mode detector and output the first and the third reference voltages respectively, the second terminal of the second resistor is coupled to the PWM controller and outputs the second reference voltage, the second terminal of the fourth resistor is coupled to the no-load mode control circuit and outputs the fourth reference voltage, and the second terminal of the fifth resistor receives a negative power voltage and is coupled to the enable circuit.

12. A switching regulator according to claim 8, wherein the voltage level shifting circuit comprises:
a first and a second switches, each of which has a first, a second, a control and a body terminals,
wherein all of the first and the body terminals of the first and the second switches, and the second terminal of the second switch are coupled to the second current source, and all of the control terminals of the first and the second switches and the second terminal of the first switch are coupled to one another and to the enable circuit, the light-load mode/heavy-load mode detector and the no-load mode control circuit.

13. A switching regulator according to claim 8, wherein the light-load mode/heavy-load mode detector is an OA having a first to a fifth input terminals and an output terminal, wherein the first and the second input terminals of the OA are coupled to the reference string circuit and receive the first and the third reference voltages respectively, the third input terminal of the OA is coupled to the voltage level shifting circuit, the enable circuit and the no-load mode control circuit, the fourth input terminal is coupled to the second current source, the fifth input terminal is coupled to the enable circuit and the no-load mode control circuit, and the output terminal is coupled to the PWM controller and the system clock.

14. A switching regulator according to claim 8, wherein the no-load mode control circuit is an OA having a first to a fourth input terminals and an output terminal, wherein the first input terminal of the OA is coupled to the voltage level shifting circuit, the enable circuit and the light-load mode/heavy-load mode detector, the second input terminal of the OA is coupled to the reference string circuit and receives the fourth reference voltage, the third input terminal of the OA is coupled to the second current source, the fourth input terminal of the OA is coupled to the enable circuit and the light-load mode/heavy-load mode detector, and the output terminal of the OA is coupled to the PWM controller.

15. A switching regulator according to claim 8, wherein the enable circuit comprises:
an inverter having an input terminal receiving the enable signal, and coupled to the light-load mode/heavy-load mode detector and the no-load mode control circuit, and an output terminal; and
a switch having a first, a second, a control and a body terminals,
wherein the second terminal of the switch is coupled to the voltage level shifting circuit, the light-load mode/heavy-load mode detector and the no-load mode control circuit, the first and the body terminals of the switch receive a negative power voltage, and the control terminal of the switch is coupled to the output terminal of the inverter.

16. A switching regulator, comprising:
a pulse-width modulation (PWM) controller generating a first pulse train and a first pulse signal;
an output driver receiving the first pulse train and generating a driving signal so as to turn an external switch on/off; and
a tri-mode clock controller, comprising:
a system clock generating a clock signal to control a timing of the first pulse train; and
a tri-mode circuitry detecting whether the first pulse signal is a narrow pulse and generating a first control signal to control a frequency of the clock signal accordingly,
wherein the switch operates under a relatively low frequency when the tri-mode circuitry operates at a light-load mode, the switch operates under a relatively high frequency when the tri-mode circuitry operates at a heavy-load mode, and the switch operates at the relatively low frequency for a pre-determined period of time and then turns off when the tri-mode circuitry operates at a no-load mode.

17. A switching regulator according to claim 16, wherein the tri-mode circuitry operates under the heavy-load mode while the narrow pulse is absent, indicating a relatively heavier external load, such that the frequency of the clock signal is switched to a relatively high frequency accordingly, the tri-mode circuitry operates under the light-load mode while the narrow pulse is detected, indicating a relatively lighter external load, such that the frequency of the clock signal is switched to a relatively low frequency accordingly, and the tri-mode circuitry operates under the no-load mode while the narrow pulse is detected and is relatively very narrow, indicating the external load is absent, such that the frequency of the clock signal is switched to the relatively low frequency for a pre-determined period of time and then drops to zero accordingly.

18. A switching regulator according to claim 16, wherein the tri-mode circuitry is a pulse width detector, and comprises:
an averaging circuit receiving the first pulse signal from the PWM and generating an average value of the first pulse signal;
a first to a third current bias circuits coupled to the averaging circuit and providing a first to a third current biases to the averaging circuit;
a light-load mode/heavy-load mode detector receiving the averaging value and a first reference voltage and generating the first control signal; and
a no-load mode control circuit receiving the averaging value and a second reference voltage and generating the second control signal,
wherein the narrow pulse is detected and the first control signal is inactive when the average value drops below the first voltage reference, the narrow pulse is absent and the first control signal is active when the average value is larger than the first voltage reference, and the narrow pulse is relatively very narrow and the second control signal is active when the average value drops below the second voltage reference.

19. A switching regulator according to claim 18, wherein the averaging circuit comprises a first and a second capacitors, each of which has a first and a second terminals, a first to a fourth switches and an inverter having an input and an output terminals, the first to the third current bias circuits comprise a fifth to a seventh switches respectively, each of the first to the seventh switches comprises a first, a second, a control and a body terminals, the third current bias circuit further comprises a third capacitor having a first and a second terminals, all of the first and the body terminals of the first, the fifth and the sixth switches, the body terminals of the second and the third switches and the first terminal of the first capacitor are coupled to a positive power voltage, all of the control terminals of the first, the fifth and the sixth switches and the second terminal of the first capacitor are coupled to an external current source, all of the first and the body terminals of the fourth and the seventh switches, the second terminal of the second switch and the second terminal of the third capacitor are coupled to a negative power voltage, the second and the control terminals of the seventh switch and the first terminal of the third capacitor are coupled to the second terminal of the fifth switch, the input terminal of the inverter is coupled to the control terminal of the second switch and receives the first pulse signal, the output terminal of the inverter is coupled to the control terminal of the third switch, the first terminals of the second and the third switches are coupled to the second terminal of the first switch, the second terminal of the third switch is coupled to the second terminal of the fourth switch, the first and second terminals of the second capacitor are coupled to the second terminal of the fourth switch and the negative power voltage respectively, the light-load mode/heavy-load mode detector is a first comparator, and the no-load mode control circuit is a second comparator.

20. A switching regulator according to claim 16, wherein the tri-mode circuitry is a narrow pulse detector, and comprises:
a setting/resetting circuit receiving a first pulse signal from the PWM controller and generating a setting/resetting signal;
a reference pulse generator generating a reference pulse;
a comparison circuit, comprising:
an analog amplifier having two inverters electrically connected in series, receiving the reference pulse and generating an amplified reference pulse; and
a latch receiving the setting/resetting signal and the amplified reference pulse and generating a second pulse train and a second pulse signal, wherein the latch is setting and resetting on a leading edge of the first pulse signal according to the setting/resetting signal, and the reference pulse generator receives the second pulse train and adjusts the reference pulse accordingly; and
an output circuit receiving the second pulse signal and generating an output signal accordingly, wherein the output signal increases in voltage if the first pulse signal is larger than the reference pulse;
a light-load mode/heavy-load mode detector receiving the output signal and a first reference voltage and generating the first control signal; and
a no-load mode control circuit receiving the output signal and a second reference voltage and generating the second control signal,
wherein the narrow pulse is detected and the first control signal is inactive when the output signal drops below the first voltage reference, the narrow pulse is absent and the first control signal is active when the output signal is larger than the first voltage reference, and the narrow pulse is relatively very narrow and the second control signal is active when the output signal drops below the second voltage reference.

21. A switching regulator according to claim 20, wherein the setting/resetting circuit comprises a first to a third inverters, each of which has an input and an output terminals, a NOR gate having a first and a second input terminals and an output terminal and a first capacitor having a first and a second terminals, the input terminals of the first and the second inverters receiving the first pulse signal, the output terminal of the first inverter and the first terminal of the first capacitor coupled to the input terminal of the third inverter, the output terminal of the second inverter coupled to the first input terminal of the NOR gate, the output terminal of the third inverter coupled to the second input terminal of the NOR gate, the output terminal of the NOR gate generating the setting/resetting signal, the comparison circuit further comprises a second capacitor having a first and a second terminals, the analog amplifier having an input and an output terminals, the latch comprises a first input terminal coupled to the output terminal of the NOR gate and the first terminal of the second capacitor, a second input terminal coupled to the output terminal of the analog amplifier and a first and a second output terminals, the reference pulse generator comprises a first and a sixth switches, a resistor having a first and a second terminals and a third capacitor having a first and a second terminals, the output circuit comprises a second to a fifth switches and a fourth capacitor having a first and a second terminals, each of the first to the sixth switches having a first, a second, a control and a body terminals, all of the first and the body terminals of the first and the second switches are coupled to a positive power voltage, all of the first and the body terminals of the fifth and the sixth switches and the second terminals of the first to the fourth capacitors are coupled to a negative power voltage, the second terminal of the first switch is coupled to the first terminal of the resistor, the second terminal of the resistor is coupled to the input terminal of the analog amplifier, the second terminal of the sixth switch and the first terminal of the third capacitor, the control terminal of the first switch is coupled to the second output terminal of the latch and the control terminal of the sixth switch, the control terminal of the second switch is coupled to the first output terminal of the latch and the control terminal of the fifth switch, the second terminal of the second switch is coupled to the first terminal of the third switch, the body terminal of the third switch is coupled to the body terminal of the second switch, the second terminal of the third switch is coupled to the second terminal of the fourth switch and the first terminal of the fourth capacitor and generates the output signal, the body terminal of the fourth switch is coupled to the body terminal of the fifth switch, and the first terminal of the fourth switch is coupled to the second terminal of the fifth switch.

22. A controlling method for a switching regulator, wherein the switching regulator comprises a system clock generating a clock signal, comprising the steps of:
(a) switching a frequency of the clock signal to a relatively high frequency while an external load is relatively heavier such that an external switch operates at the relatively high frequency accordingly;
(b) switching the frequency of the clock signal to a relatively low frequency while the external load is relatively lighter such that the external switch operates at the relatively low frequency accordingly; and
(c) switching the frequency of the clock signal to the relatively low frequency for a pre-determined period of time and then dropping the frequency to zero such that the external switch operates at the relatively low frequency for the pre-determined period of time and then turns off.

23. A controlling method according to claim 22, wherein the switching regulator further comprises a pulse-width modulation (PWM) controller, an output driver and a tri-mode clock controller having the system clock and a tri-mode circuitry, and the step (a) further comprises the steps of:
(a1) causing the PWM controller to receive a feedback signal of an output voltage across the external load and to generate a pulse train;
(a2) controlling a timing of the pulse train via the clock signal;
(a3) causing the output driver to receive the pulse train and generate a driving signal so as to turn the external switch on and off accordingly; and
(a4) causing the tri-mode circuitry to receive the feedback signal and generate a control signal to control the frequency of the clock signal accordingly.

24. A controlling method according to claim 22, wherein the switching regulator further comprises a pulse-width modulation (PWM) controller, an output driver and a tri-mode clock controller having the system clock and a tri-mode circuitry detecting a narrow pulse and generating a control signal to control a frequency of the clock signal according to whether the narrow pulse is detected, and the step (a) further comprises the steps of:
(a1) causing the PWM controller to receive a feedback signal of an output voltage across the external load and generate a pulse signal and a pulse train;
(a2) controlling a timing of the pulse train via the clock signal;
(a3) causing the output driver to receive the pulse train and generate a driving signal so as to turn the external switch on and off accordingly; and
(a4) causing the tri-mode circuitry to receive the pulse signal and generating a control signal to control a frequency of the clock signal according to whether the pulse signal is a narrow pulse.

25. A controlling method according to claim 24, wherein the step (a4) further comprises the steps of:
(a41) causing the frequency of the clock signal to switch to a relatively high frequency while the narrow pulse is absent;
(a42) causing the frequency of the clock signal to switch to a relatively low frequency while the narrow pulse is detected; and
(a43) causing the frequency of the clock signal to switch to the relatively low frequency for a pre-determined period of time and then to drop to zero while the narrow pulse is detected and is relatively very narrow.
